(19) United States
(12) Patent Application Publication
(10) Pub. No.: US 2001/0032219 A1
(43) Pub. Date: Oct. 18, 2001

(54) Web page illustration creation method

(76) Inventor: Anton Issinski, Toronto (CA)

Correspondence Address: UNIPORT CORPORATION, 614 - 980 YONGE STREET, TORONTO, ON, M4W 3V8, CA

(21) Appl. No.: 09/835,546

(22) Filed: Apr. 17, 2001

(30) Foreign Application Priority Data
Apr. 17, 2000 (CA) 2305038

(51) Int. Cl. G06F 15/00

(52) U.S. Cl. 707/513; 707/500

(57) ABSTRACT

In addition to widely spread bitmap types of images like JPEG or TIFF used to represent illustrations in World Wide Web pages this invention provides a simple way of creating vector, or outline type of images using existing features of Java-enabled browsers without introducing new image formats.

The idea is to create a tool for the Web page developer that will take a vector graphical image and convert it into a set of Java drawing commands finally forming a Java applet.

The client's browser then will display the applet in the Web page, as it would be a regular graphical image.

The benefits of this method are higher image compression rate and scalability.

### DESCRIPTION

This invention relates to the Internet Web page graphical illustration creation process.

There are many well-known methods to create a graphical illustration for a Web page. The most common is based on creating graphical image files in a format supported by page browsers.

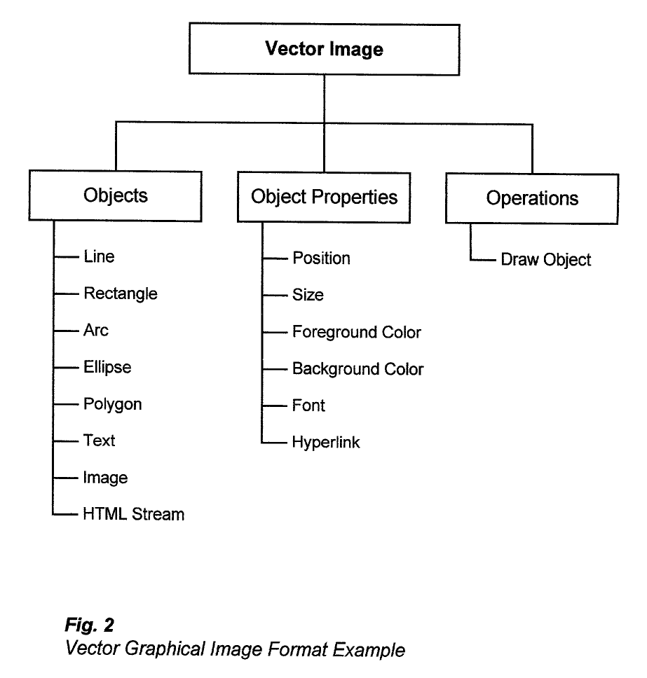

At the present time, the Internet standard graphical image formats are JPEG, GIF and TIFF. That graphical formats belong to a class of bitmap formats for graphics presentation. It means that the image is represented as a set of dots, or pixels of different colors together forming a whole image. Being good for some types of images like photo pictures they have two major disadvantages for diagram sort of images—they take relatively large amount of space and are not scalable. The alternative class of graphical format known and referred here as a vector format uses graphical pseudo codes like “draw a line” or “draw a rectangle” or “display the text” instead of pixel representation (FIG. 2). For example, Microsoft Windows Metafile (WMF) format is a subset of Vector class of formats.

At the present time there is no any accepted standard vector type formats to represent graphical images in Web pages in the Internet. This limits the flexibility of a Web page design and increases overall network traffic.

However, introducing a new vector graphical format or adopting existing one will take a time and a certain amount of efforts, including efforts in modification of all browsers to support that new format.

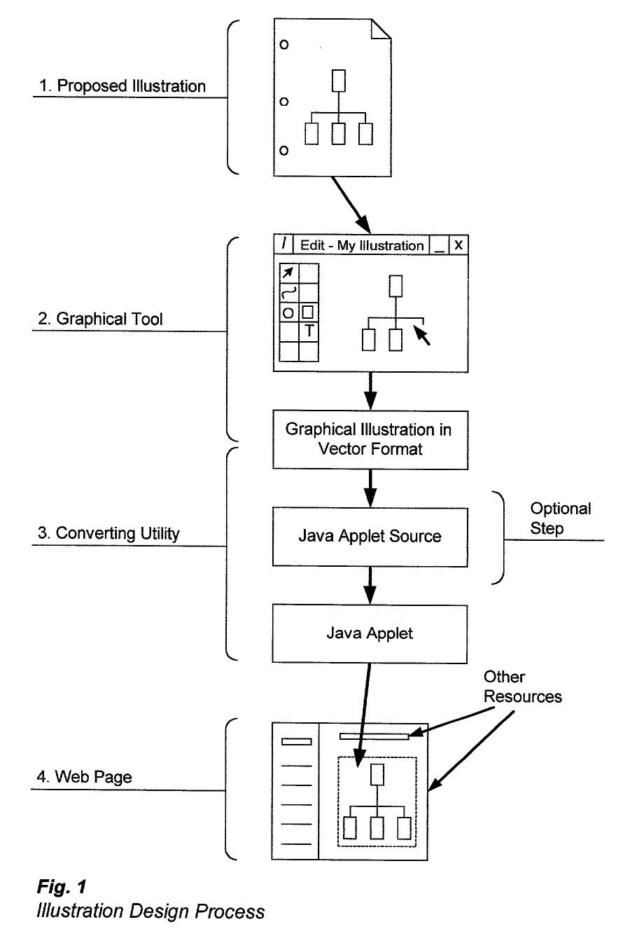

These disadvantages may be overcome by creating a special type of graphical editor (FIG. 1) to be used by the Web page designer.

That graphical editor (2) will produce graphical data in the vector format and then convert (3) vector images into a set of Java codes that are capable of supporting commands like “draw a line”, “draw a rectangle” or “display a text”.

Resulting Java codes then are linked by the converting utility (3) into a special type of Java applet, simply consisting of vector drawing commands.

Because all modern browsers support Java applets, the resulting applet binary image can be inserted into a Web page (4) as an illustration image without any compatibility problems and will be of the desired vector type.

These “Vector Applet” images will have significant advantages over classical bitmap files. For example:

(a) The size of vector applet is less then the size of the bitmap image for a wide range of illustrations such as diagrams, charts, graphs and other presentation drawing objects.

(b) Vector images are easy to scale without distorting and loosing a resolution. Web page browsers may resize vector images according to client's computer screen resolution.

(c) Vector images are easier to edit then the bitmap ones. For example, graphical objects forming the vector image may be scaled or moved inside the image independently.

One of the implementations of this patent method could be “Graphical Filter” plug-in software for the present computer graphical editors. When installed, this graphical filter will add an option to the “Save As . . .” or “Export . . .” editor commands enabling saving output data in the said Vector Applet Image format. The same functionality can be added to the “Open . . .” or “Import . . .” commands in advanced implementations to load image data in the applet format.

The significant amount of efforts have been made by software development companies to produce graphical tools to automate the process of creating windows, dialog boxes, controls and other user interaction elements of software programs, including Java applet programs. One can use a variety of graphical tools to design say, a dialog box resource for a Java program, then compile it into a working Java applet. But all that tools are programming-oriented and are not intended to be used as graphical illustration producers.

For example, using those tools, it is very unlikely that one without Java language programming skills will be able to draw a simple say logical diagram or a flow chart illustration and without manually writing special Java codes to assemble the picture.

On the other hand, graphical image editor tools for the Internet Web page developing offer saving of the image in a bitmap type format to be compatible with the most of Internet browsers and are not able to produce Java applets as an output image.

1. A method of producing computer graphical illustration comprising a computer graphical illustration editor that produces an output graphical data in a form of Web page applet codes.

2. A method of producing computer graphical illustration comprising
(a) a computer tool for producing graphical illustration data of a vector type,
(b) an utility that converts said graphical illustration data into Web page applet codes.

3. A method of producing computer graphical illustration comprising
(a) a graphical illustration data of a vector type,
(b) an utility that converts said graphical illustration data into Web page applet codes.

4. A method of storing, transmitting or displaying graphical illustration data where said data is a result of converting graphical illustration data into Web page applet codes.

5. A method of claims 1-4 where said Web page applet codes is a Java class or Java applet.

6. A method of claims 1-4 where said Web page applet codes are Java script codes.

7. A method of claims 14 where said Web page applet codes are Microsoft Visual Basic script codes.

8. A method of claims 1-7 where said graphical illustration is a Web page graphical illustration.

9. A method of claims 1-7 where said graphical illustration is an entire Web page or a part of Web page.
